(19) United States
(12) Patent Application Publication
(10) Pub. No.: US 2025/0355330 A1
(43) Pub. Date: Nov. 20, 2025

(54) INSTALLATION STRUCTURE AND ELECTRONIC DEVICE KIT

(71) Applicant: TILTA INC., Burbank, CA (US)

(72) Inventors: Zhichao FENG, Shenzhen (CN); Wenping ZENG, Shenzhen (CN); Kefeng ZHOU, Shenzhen (CN)

(21) Appl. No.: 19/202,740

(22) Filed: May 8, 2025

(30) Foreign Application Priority Data
May 18, 2024 (CN) 2024210907391

(51) Int. Cl. G03B 17/56; F16M 13/00; H04M 1/02

(52) U.S. Cl. CPC G03B 17/565; F16M 13/005; H04M 1/0203

(57) ABSTRACT

The present application provides an installation structure, including a mounting base, a mounting bracket, and a quick-release assembly. The mounting bracket is movably connected to the mounting base and is used for mounting an optical lens or camera lens. The quick-release assembly includes a clamping member and a trigger. The clamping member is movably arranged on the mounting base and includes a first clamping member and a second clamping member that are arranged opposite each other. The triggering member is movably arranged on the mounting base and can trigger the first clamping member and the second clamping member to clamp onto an external structure.

### CROSS-REFERENCE TO RELATED APPLICATIONS

The present application for patent claims priority to and the benefit of pending Chinese Application No. 2024210907391, filed May 18, 2024, and hereby expressly incorporated by reference herein as if fully set forth below in its entirety and for all applicable purposes.

### TECHNICAL FIELD

The present disclosure pertains to the technical field of photography accessories, specifically to an installation structure and an electronic device kit.

### INTRODUCTION

With the widespread adoption of photography and videography, an increasing number of individuals engage in shooting activities as part of their daily routines. During the shooting process, people often have varying composition requirements and, consequently, frequently need to attach various photography accessories, such as camera lenses or optical lenses, to the electronic devices used for shooting. Currently, users primarily attach these accessories to the electronic devices by screwing them into place. When needing to switch to other photography accessories, they can use tools such as screwdrivers, for instance, hex wrenches, to remove the installed accessories and then attach new ones. This method allows various photography accessories to be securely installed on the casing of the electronic device, but it is inconvenient during the installation and removal process, thereby significantly impacting the shooting experience.

### BRIEF SUMMARY

The present disclosures provides an installation structure and an electronic device kit, aiming to address the inconvenience in the installation and removal of various photography accessories in the prior art, which significantly impacts the shooting experience.

The present disclosure is as follows:

an installation structure, including:

a mounting base;

a mounting bracket movably connected to the mounting base and used for mounting an optical lens or camera lens;

a quick-release assembly, including a clamping member and a trigger; wherein the clamping member is movably arranged on the mounting base and includes a first clamping member and a second clamping member arranged opposite each other; and wherein the trigger is movably arranged on the mounting base and can trigger the first clamping member and the second clamping member to clamp onto an external structure.

### BRIEF DESCRIPTION OF THE DRAWINGS

To elucidate the technical solutions presented in some aspects of the present disclosure, the accompanying drawings for describing these examples will be briefly introduced below. It is apparent that the accompanying drawings described herein represent merely some examples of the present disclosure. For those skilled in the art, without the necessity for inventive effort, other drawings can be derived based on the structures depicted in these drawings.

FIG. 1 is a diagram illustrating an electronic device kit according to some aspects of the disclosure.

FIG. 2 is diagram illustrating an exploded structural schematic diagram of an installation structure according to some aspects of the disclosure.

FIG. 3 is a diagram illustrating another installation structure with a threaded mounting opening according to some aspects of the disclosure.

FIG. 4 is a diagram illustrating another installation structure with a T-mount according to some aspects of the disclosure.

FIG. 5 is a diagram illustrating another installation structure with a M-mount according to some aspects of the disclosure.

FIG. 6 is a diagram illustrating an exploded schematic diagram of the installation structure according to some aspects of the disclosure.

FIG. 7 is a diagram illustrating a rear view of the installation structure according to some aspects of the disclosure.

FIG. 8 is a diagram illustrating a cross-sectional diagram in the A-A plane of FIG. 7 of the disclosure.

FIG. 9 is a diagram illustrating a top view of the installation structure according to some aspects of the disclosure.

FIG. 10 is a diagram illustrating a cross-sectional diagram in the B-B plane of FIG. 9 of the disclosure.

### REFERENCE NUMBERS

100-electronic device kit;

101-installation structure;

102-housing;

1021-receiving cavity;

1022-locking groove;

103-expansion interface;

1-mounting base;

2-mounting bracket;

21-threaded mounting opening;

22-T-mount;

23-M-mount;

24-first bracket;

241-opening;

242-magnet;

243-mounting part;

244-positioning part;

245-limiting part;

246-limiting groove;

247-snap-fit groove;

25-second bracket;

251-connecting part;

252-lens part;

253-fixture block;

26-first retaining groove;

27-receiving groove;

3-quick-release assembly;

31-clamping member;

311-first clamping member;

312-second clamping member;

313-first inclined surface;

314-second inclined surface;

32-trigger;

321-first groove;

322-second groove;

323-inner wall;

324-first groove segment;

325-trigger button;

326-trigger block;

327-second groove segment;

4-locking assembly;

41-locking member;

411-operating part;

412-hook part;

413-second retaining groove;

42-rotating shaft;

43-torsion spring;

5-limiting member;

51-first stopper post;

52-second stopper post;

53-first resilient member;

54-second resilient member.

The objectives, functional features, and aspects of the disclosure will be further elaborated with reference to the accompanying drawings and in conjunction with specific examples.

### DETAILED DESCRIPTION

The subsequent passages provide a portrayal of the technical solutions embodied within this disclosure, drawing upon the illustrative figures. It is to be understood that the enumerated examples constitute but a fraction of the broader scope and are not exhaustive. Consequently, any alternative examples derived by ordinary technicians in the relevant field, without the necessity for inventive ingenuity, are encompassed within the protective ambit of the disclosure.

Please be advised that directional terminology (e.g., up, down, left, right, front, rear, etc.) employed in the examples serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in the disclosure, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct examples is permissible, albeit contingent upon the feasibility of such integration by ordinary technicians in the field. In instances where the combined technical solutions conflict or are unfeasible, such integrations are deemed non-existent and thereby excluded from the scope of protection afforded by the disclosure.

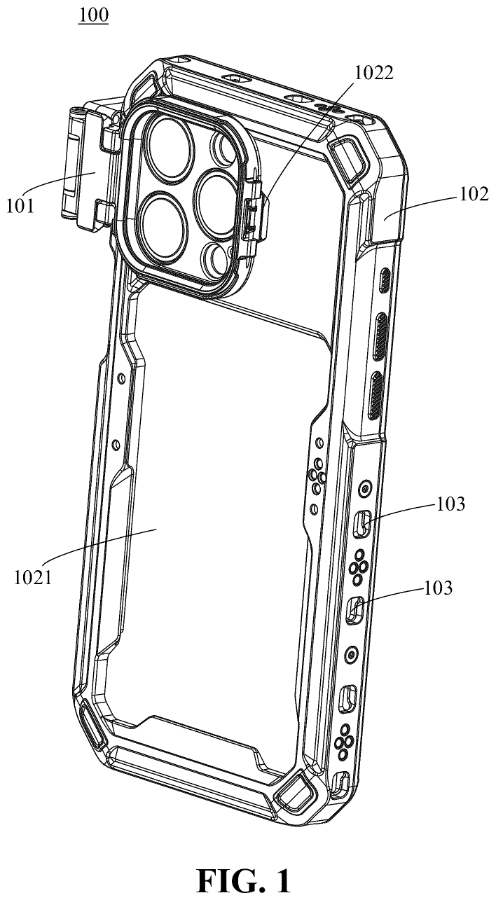

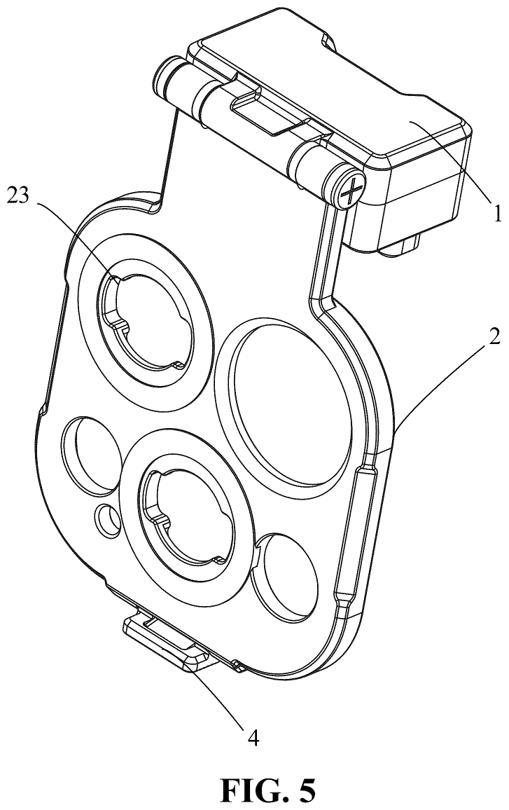

With reference to FIGS. 1-10, the present disclosure provides an electronic device kit 100 including an installation structure 101 and a housing 102. The housing 102 is provided with an expansion interface 103, and the installation structure 101 is connected to the housing 102 through the expansion interface 103. The housing 102 has a receiving cavity 1021, which is used to accommodate an electronic device such as a mobile phone. The installation structure 101 is arranged on the housing 102 for installing camera lenses or optical lenses. In some examples, the installation structure 101 can be referred to as a mounting structure.

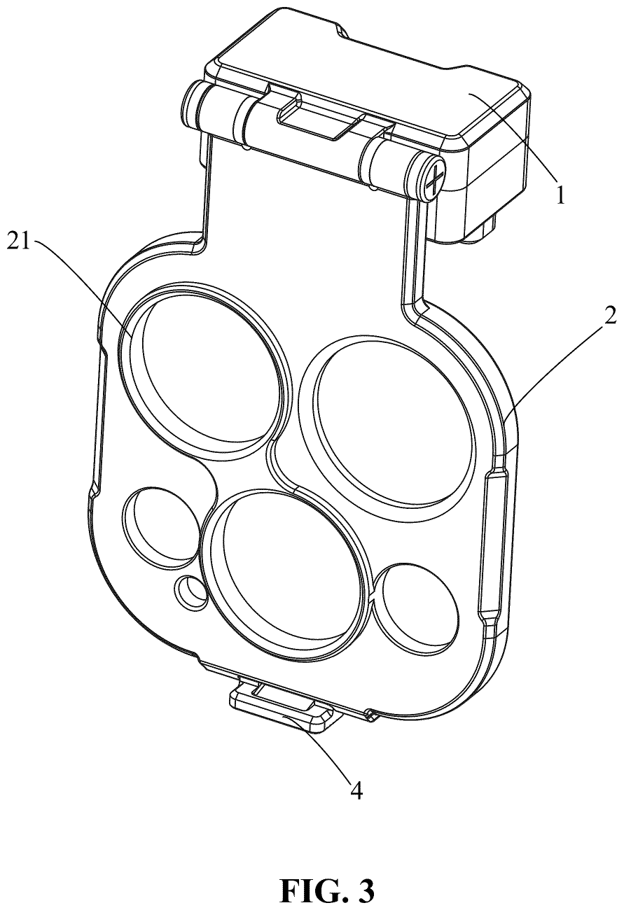

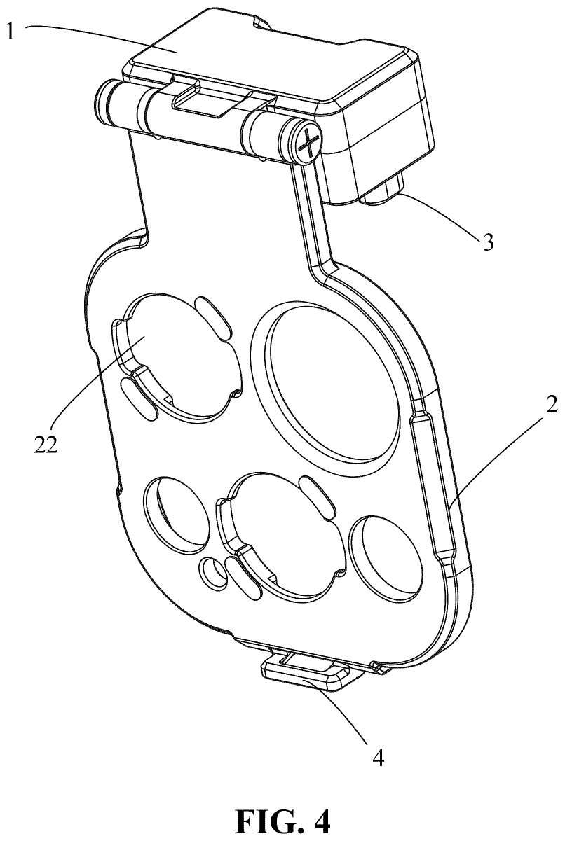

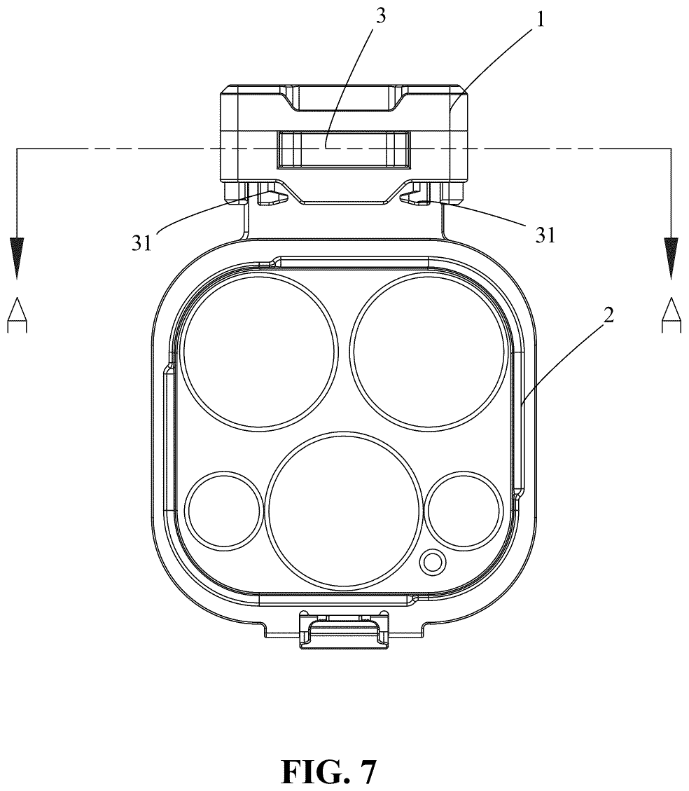

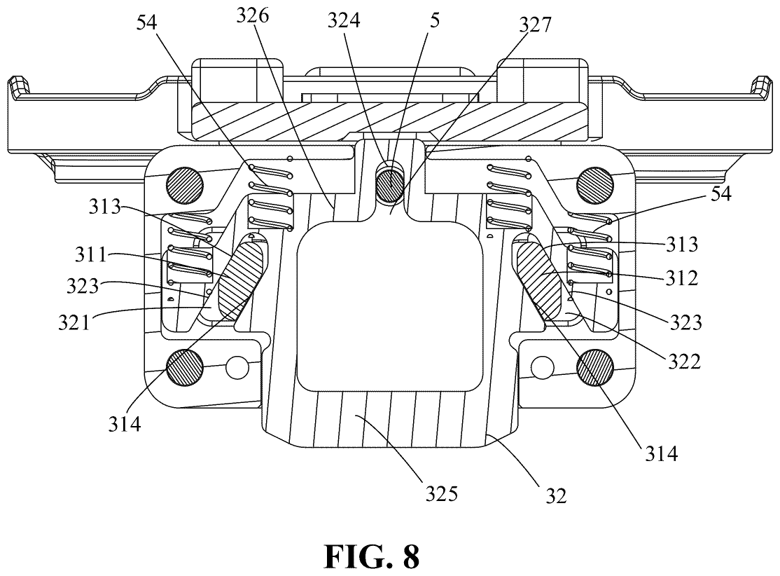

Specifically, reference to FIGS. 3-4, the installation structure 101 includes a mounting base 1, a mounting bracket 2, and a quick-release assembly 3. The mounting bracket 2 is movably connected to the mounting base 1 and is used for directly installing camera lenses or optical lenses. Reference to FIGS. 7-8, the quick-release assembly 3 includes a clamping member 31 and a trigger 32. The clamping member 31 is movably arranged on the mounting base 1 and includes a first clamping member 311 and a second clamping member 312 arranged opposite each other. The trigger 32 is movably arranged on the mounting base 1 and can trigger the first clamping member 311 and the second clamping member 312 to clamp onto an external structure.

In some aspects, the mounting base 1 can be quickly installed onto an electronic device or the electronic device kit 100 through the quick-release assembly 3. The mounting bracket 2 can be rotated relative to the mounting base 1 to approach the lens of the electronic device. Then, an optical lens (e.g., a lens filter) or a camera lens can be installed through the mounting bracket 2, thereby completing the extended connection of the camera lens or optical lens of the electronic device, facilitating shooting.

Specifically, with reference to FIGS. 3-5, the mounting bracket 2 may be provided with at least one of a threaded mounting opening 21, a T-mount 22, and an M-mount 23 (the T-mount 22 and M-mount 23 are a type of interface used to connect a T series lens and M series lens with mount tabs, respectively, e.g., T series Moment lens and M series Moment lens; T series Fotorgear lens) to adapt to camera lenses with different interfaces on the market, thereby facilitating flexible use by the user. As shown in the drawing illustrating the threaded mounting opening 21, the user can directly thread a camera lens onto the mounting bracket 2. As shown in the drawing illustrating the T-mount 22, the user can install a camera lens compatible with this interface onto the mounting bracket 2. As shown in the drawing illustrating the M-mount 23, the user can install a lens compatible with this interface onto the mounting bracket 2.

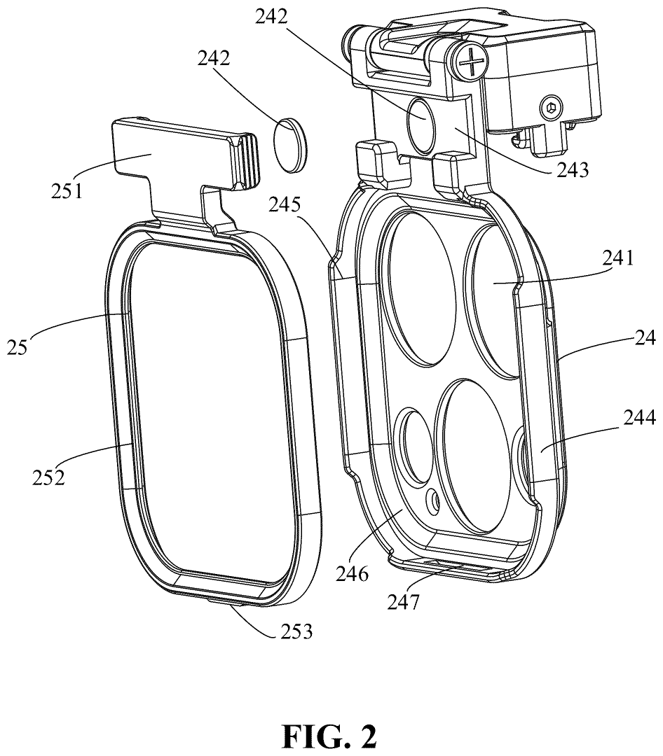

In another aspect, with reference to FIG. 2, the mounting bracket 2 includes a first bracket 24 and a second bracket 25. The first bracket 24 is provided with an opening 241 for exposing the camera lens of the electronic device, and the second bracket 25 is used for installing optical lenses and is detachably connected to the first bracket 24. In some aspects, a filter can be directly installed on the first bracket 24 through the second bracket 25. This setup allows the user to install different filters through the second bracket 25. During shooting, the user can replace the second bracket 25 with different filters according to their needs and further install it on the first bracket 24 for convenient use.

The first bracket 24 and the second bracket 25 are provided with magnets 242 for mutual attraction, and the first bracket 24 and the second bracket 25 are detachably connected through the mutual attraction of the magnets 242, which is cost-effective and simple to operate. In other aspects, the magnets 242 can be configured in different forms such as magnetic sheets or magnetic strips according to specific situations.

The first bracket 24 includes a mounting part 243 and a positioning part 244. The mounting part 243 is rotatably connected to the mounting base 1, and the positioning part 244 is configured to surround the periphery of the electronic device lens. The openings 241 are all provided within the positioning part 244, and the specific locations, quantities, and configurations of the openings 241 are set according to the model of the electronic device. Existing mobile phone lenses are typically protruded relative to the phone body. The openings 241, in conjunction with the lens, can also be used to position the installation location of the first bracket 24. The positioning part 244 can rotate away from or towards the electronic device lens through the mounting part 243. The second bracket 25 includes a connecting part 251 and a lens part 252. The magnet 242 is disposed between the connecting part 251 and the mounting part 243, and the connecting part 251 cooperates with and is magnetically attracted to the mounting part 243. The lens part 252 is used for mounting an optical lens and cooperates with the positioning part 244. After the connecting part 251 is magnetically attracted and fixed to the mounting part 243, the optical lens of the lens part 252 covers the positioning part 244, i.e., it covers the electronic device lens.

Referring to the FIG. 2, the positioning part 244 is provided with a limiting part 245 along its periphery, and the limiting part 245 and the positioning part 244 form a limiting groove 246 for the lens part 252 to be embedded into. When in use, the lens part 252 is enclosed within the limiting groove 246 formed by the limiting part 245 and the positioning part 244, providing support, limitation, and anti-deviation for the lens part 252, thereby enhancing the relative stability between the lens part 252 and the electronic device.

With reference to FIG. 2, to further ensure stability between the optical lens and the electronic device lens, a fixture block 253 is provided on the side of the lens part 252 opposite the connecting part 251. Additionally, a snap-fit groove 247 is provided in the limiting part 245 for the insertion of the fixture block 253. When the fixture block 253 is inserted into the snap-fit groove 247, the magnet 242 on the connecting part 251 is attracted to the magnet 242 on the mounting part 243. The cooperative insertion of the fixture block 253 and the snap-fit groove 247 facilitates pre-positioning of one end of the first bracket 24 and the second bracket 25. Subsequently, the other end of the first bracket 24 and the second bracket 25 can be fixed through the attraction of the two magnets 242, thereby ensuring stability between the first bracket 24 and the second bracket 25 and further enhancing the stability between the optical lens and the electronic device lens.

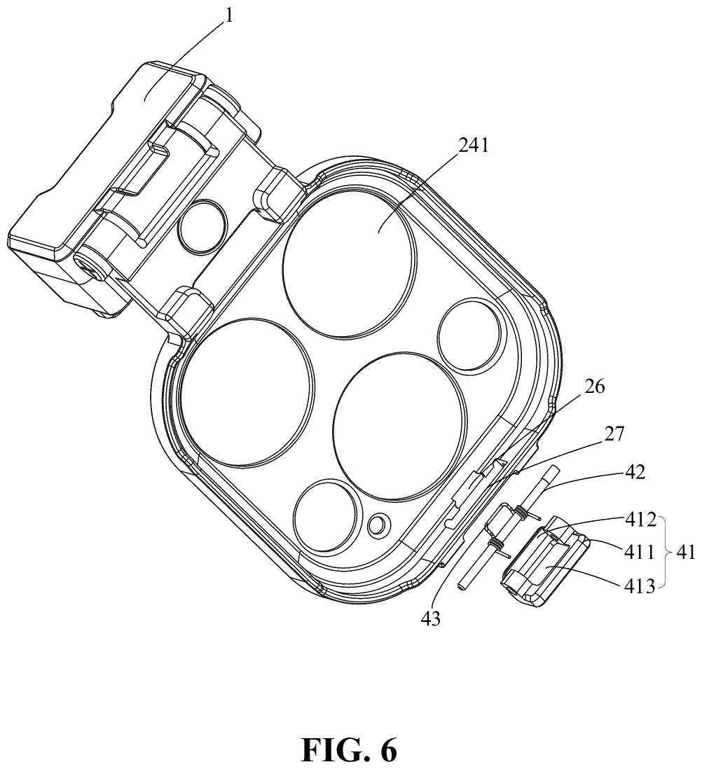

Referring to FIG. 6, in some aspects, the installation structure 101 further includes a locking assembly 4, which is disposed on the mounting bracket 2 and can be locked to an external structure (e.g., locking the housing 102). The mounting bracket 2 can rotate relative to the mounting base 1. In some aspects, damping can be added to the rotating shaft connecting the mounting bracket 2 and the mounting base 1, allowing the mounting bracket 2 to hover at different angles relative to the electronic device. Considering that in some cases, the user may inadvertently touch the mounting bracket 2, causing it to rotate or swing. If a camera lens or an optical lens is mounted on the mounting bracket 2 at this time, it may be damaged during the movement. Therefore, in another embodiment, the locking assembly 4 can also be configured to lock the mounting bracket 2 to an external structure, allowing the mounting bracket 2 to be stably installed on the external structure. It is understood that the external structure, in some aspects, can be the housing 102 of the electronic device, such as a mobile phone case or an iPad housing 102.

In one aspect, referring to FIG. 6, the locking assembly 4 includes a locking member 41 and a rotating shaft 42. The rotating shaft 42 is disposed at one end of the mounting bracket 2 away from the quick-release assembly 3, and the locking member 41 is movably connected to the rotating shaft 42. In some aspects, a locking groove 1022 can be provided on the housing 102. The user can rotate the locking member 41 to engage it in the locking groove 1022, thereby locking the mounting bracket 2 to the housing 102.

Specifically, the locking assembly 4 further includes a torsion spring 43. A receiving groove 27 is provided at one end of the mounting bracket 2 away from the quick-release assembly 3, and the rotating shaft 42 is disposed within the receiving groove 27. The torsion spring 43 is sleeved over the receiving groove 27, with one end abutting or connected to the mounting bracket 2 and the other end abutting or connected to the locking member 41. This configuration ensures that when the user releases the locking member 41, it can be stably locked in the locking groove 1022 under the elastic force of the torsion spring 43.

Specifically, referring to FIGS. 1 and 6, a first retaining groove 26 is provided on the mounting bracket 2. The locking member 41 includes an operating part 411 and a hook part 412, and the operating part 411 is provided with a second retaining groove 413. One end of the torsion spring 43 abuts against the first retaining groove 26, and the other end abuts against the second retaining groove 413, to prevent the torsion spring 43 from slipping off and thereby ensure the stability of the structure.

Referring to FIGS. 7-8, the quick-release assembly 3 includes a clamping member 31 and a trigger 32. The clamping member 31 is movably disposed on the mounting base 1 and includes a first clamping member 311 and a second clamping member 312 disposed opposite each other. The trigger 32 is movably disposed on the mounting base 1 and is provided with a first groove 321 and a second groove 322 corresponding to the first clamping member 311 and the second clamping member 312, respectively. The first clamping member 311 is received within the first groove 321, and the second clamping member 312 is received within the second groove 322. The trigger 32 can trigger the first clamping member 311 and the second clamping member 312 to move away from or move towards each other through the first groove 321 and the second groove 322.

In some aspects, the trigger 32 can be actuated, and through the first groove 321 and the second groove 322 of the trigger 32, the first clamping member 311 and the second clamping member 312 can be driven to move away from each other, increasing the clamping space between the first clamping member 311 and the second clamping member 312 and placing the assembly in a standby installation state. When the first clamping member 311 and the second clamping member 312 are installed on the housing 102, the trigger 32 can reset and further drive the first clamping member 311 and the second clamping member 312 to move towards each other through the first groove 321 and the second groove 322, thereby clamping the quick-release mechanism to the housing 102. At this point, it is in a clamping state. In some aspects, the quick-release assembly 3 can be quickly installed on or removed from the housing 102. When the quick-release assembly 3 is equipped with the mounting bracket 2, the mounting bracket 2 can be quickly installed on or removed from the housing 102 through the quick-release assembly 3, thereby facilitating the photography process for users.

Specifically, referring to FIGS. 7-8, in one aspect, the inner walls 323 of the first groove 321 and the second groove 322 are inclined surfaces, allowing the first clamping member 311 to cooperate with the inclined surface of the inner wall 323 of the first groove 321, and the second clamping member 312 to cooperate with the inclined surface of the inner wall 323 of the second groove 322, thereby driving the first clamping member 311 and the second clamping member 312 to move away from or towards each other. In some aspects, when the trigger 32 is pressed, the inclined surfaces of the inner walls 323 of the first groove 321 and the second groove 322 can push the first clamping member 311 and the second clamping member 312 to slide along the inner walls 323, enabling the first clamping member 311 and the second clamping member 312 to be used for mounting the housing 102 of the electronic device. After being mounted on the housing 102 of the electronic device, the trigger 32 can reset, at which point the inclined surfaces of the inner walls 323 of the first groove 321 and the second groove 322 can push the first clamping member 311 and the second clamping member 312 to also reset, thereby causing the first clamping member 311 and the second clamping member 312 to press against the housing 102 of the electronic device. It is understood that both relative sides of the first clamping member 311 and the second clamping member 312 have a first inclined surface 313 and a second inclined surface 314, and at least one of the first inclined surface 313 and the second inclined surface 314 abuts against the inner wall 323 of the first groove 321 and the second groove 322, respectively. Preferably, the first inclined surface 313 and the second inclined surface 314 are arranged in parallel. On the other hand, the area between the first inclined surface 313 and the second inclined surface 314 can be transitioned with a curved surface to facilitate smooth movement of the first inclined surface 313 and the second inclined surface 314 within the first groove 321 and the second groove 322, respectively.

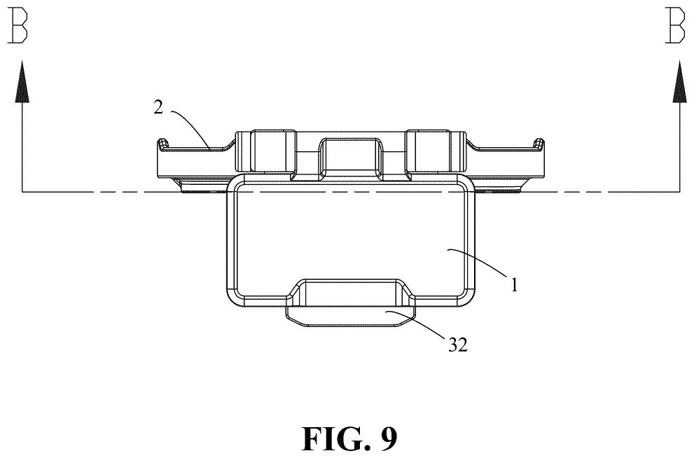

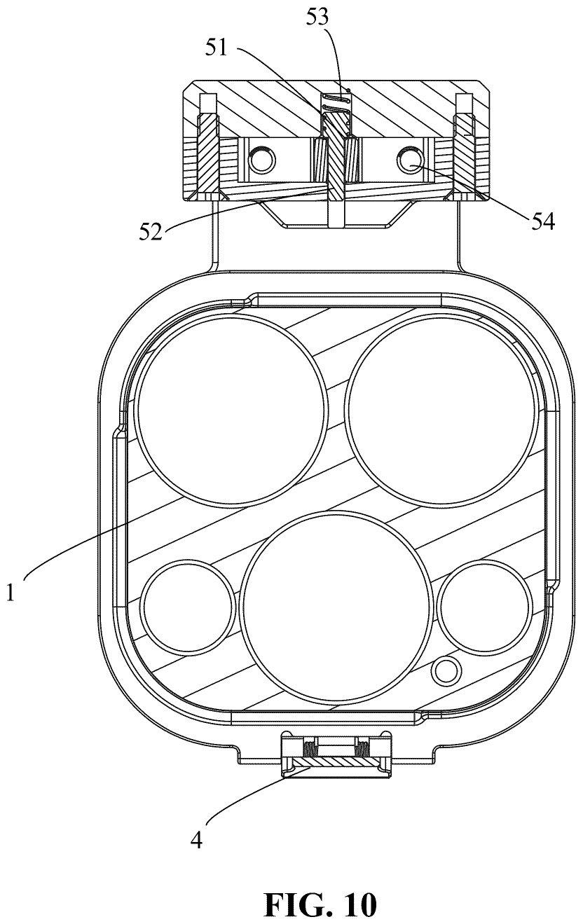

In other aspects, with reference to FIGS. 9-10, the quick-release assembly 3 further includes a limiting member 5. The trigger 32 is provided with a first groove segment 324 of a limiting groove 246. The limiting member 5 is housed in the first groove segment 324 of the limiting groove 246 and is movably connected to the mounting base 1. When the trigger 32 moves towards the limiting member 5, the limiting member 5 can disengage from the first groove segment 324 of the limiting groove 246 and restrict the movement of the trigger 32. The limiting member 5 can move outward from the mounting base 1, allowing at least a part of its structure to protrude outside the mounting base 1. Specifically, In some aspects, the trigger 32 includes a trigger button 325 and a trigger block 326. The trigger button 325 is connected to the trigger block 326 and is exposed outside the mounting base 1. The trigger block 326 is movably connected to the mounting base 1. The first groove 321 and the second groove 322 are inclinedly arranged on the trigger block 326 in opposite directions from the end of the trigger block 326 close to the limiting member 5. When the trigger button 325 actuates the trigger block 326 to move towards the limiting member 5, the first clamping member 311 and the second clamping member 312 move away from each other, entering a ready-to-install state. When the first clamping member 311 and the second clamping member 312 clamp onto an external structure, the external structure can trigger the limiting member 5 to return towards the inside of the mounting base 1. The return of the limiting member 5 can drive the trigger block 326 to return, causing the first clamping member 311 and the second clamping member 312 to enter a clamped state. In some aspects, the external structure can be the housing 102 of the electronic device. In the installed state, the first clamping member 311 and the second clamping member 312 move away from each other, and at this time, the limiting member 5 is also exposed outside the mounting base 1. When the second clamping member 312 and the first clamping member 311 are clamped onto the housing 102 of the electronic device, the limiting member 5 presses against the outer sidewall of the housing 102, thereby being able to retract towards the inside of the mounting base 1. At this point, the trigger block 326 can return, and the limiting member 5 re-engages with the first groove segment 324 of the limiting groove 246, with the first clamping member 311 and the second clamping member 312 also entering a clamped state.

Specifically, the limiting member 5 includes a first stopper post 51 and a second stopper post 52, and a first resilient member 53 is arranged between the first stopper post 51 and the base. The diameter of the first stopper post 51 is greater than that of the second stopper post 52, and the second stopper post 52 can engage with the first groove segment 324 of the limiting groove 246. When the trigger button 325 is pressed, the trigger block 326 is pushed to move, causing the second stopper post 52 to disengage from the first groove segment 324 of the limiting groove 246. At this point, the first resilient member 53 can cause the second stopper post 52 to move towards the outside of the mounting base 1, and the first stopper post 51 follows the second stopper post 52. Since the diameter of the first stopper post 51 is greater than that of the second stopper post 52, it is difficult for the first stopper post 51 to engage with the first groove segment 324 of the limiting groove 246, thus restricting the movement of the trigger block 326. At this point, the first clamping member 311 and the second clamping member 312 are in a ready-to-install state. When the second clamping member 312 and the first clamping member 311 clamps onto the housing 102 of the electronic device, the second stopper post 52 presses against the outer sidewall of the housing 102, thereby moving towards the inside of the mounting base 1. At this point, the first stopper post 51 also moves towards the inside of the mounting base 1, and the first resilient member 53 is in a compressed state. The first stopper post 51 no longer restricts the movement of the trigger block 326, and the trigger block 326 immediately returns. The second stopper post 52 re-engages with the first groove segment 324 of the limiting groove 246, and the first clamping member 311 and the second clamping member 312 can now enter a clamped state. More specifically, the trigger block further includes a second groove segment 327 of an receiving groove 27, which is used to accommodate the first stopper post 51 and is connected to the first groove segment 324 of the limiting groove 246. When the trigger button 325 is pressed, it can push the trigger block 326 to move, causing the second stopper post 52 to disengage from the first groove segment 324 of the limiting groove 246. At this point, the first stopper post 51 can be housed in the second groove segment 327 of the receiving groove 27 to restrict the movement of the trigger block 326. When the second stopper post 52 presses against the outer sidewall of the housing 102 and moves towards the inside of the mounting base 1, the first stopper post 51 exits the second groove segment 327 of the receiving groove 27, and the trigger block resets, with the second stopper post 52 re-engaging with the first groove segment 324 of the limiting groove 246. It is understood that, In some aspects, a second resilient member 54 is arranged between the trigger block 326 and the mounting base 1. After the first stopper post 51 exits the second groove segment 327 of the receiving groove 27, the second resilient member 54 can drive the trigger block 326 to return.

What is claimed is:

1. An installation structure, comprising:
a mounting base;
a mounting bracket movably connected to the mounting base and configured for mounting an optical lens or camera lens;
a quick-release assembly comprising a clamping member and a trigger;
wherein the clamping member is provided on the mounting base and comprises a first clamping member and a second clamping member provided opposite to each other; and
wherein the trigger is movably provided on the mounting base and is configured to trigger the first clamping member and the second clamping member to clamp onto an external structure.

2. The installation structure according to claim 1, wherein the mounting bracket comprises at least one of a threaded mounting opening, a T-mount, and an M-mount.

3. The installation structure according to claim 1, wherein the mounting bracket comprises a first bracket and a second bracket; and
wherein the first bracket is provided with an opening for exposing a camera lens of an electronic device, and the second bracket is configured for mounting an optical lens and is detachably connected to the first bracket.

4. The installation structure according to claim 1, wherein the trigger is provided with a first groove corresponding to the first clamping member and a second groove corresponding to the second clamping member;
wherein the first clamping member is accommodated in the first groove, and the second clamping member is accommodated in the second groove; and
wherein the trigger is configured to trigger the first clamping member and the second clamping member to move relative to each other through the first groove and the second groove.

5. The installation structure according to claim 4, wherein the first groove comprises an inclined inner wall and the second groove comprises an inclined inner wall; and
wherein the first clamping member cooperates with the inclined inner wall of the first groove, and the second clamping member cooperates with the inclined inner wall of the second groove, to drive the first clamping member and the second clamping member to move relative to each other.

6. The installation structure according to claim 5, wherein the quick-release assembly further comprises a limiting member;
wherein the trigger comprises a trigger button and a trigger block, the trigger button is connected to the trigger block and is exposed outside the mounting base;
wherein the trigger block is movably connected to the mounting base, and the first groove and the second groove are inclined in opposite directions from an end of the trigger block near the limiting member;
in response to an actuation of the trigger button, the trigger block is configured to move to drive the limiting member to exit a limiting groove, and the first clamping member and the second clamping member move away from each other to enter a standby installation state;
in response to the first clamping member and the second clamping member clamping onto the external structure, the external structure is configured to trigger the limiting member to reset inside the mounting base, enabling the limiting member to drive the trigger block to reset, causing the first clamping member and the second clamping member being in a clamped state.

7. The installation structure according to claim 1, further comprising a locking assembly;
wherein the locking assembly is provided on the mounting bracket and is configured to lock onto the external structure.

8. The installation structure according to claim 7, wherein the locking assembly comprises a locking member and a rotating shaft; and
wherein the rotating shaft is provided at one end of the mounting bracket away from the quick-release assembly, and the locking member is movably connected to the rotating shaft.

9. The installation structure according to claim 8, wherein the locking assembly further comprises a torsion spring; and
wherein one end of the mounting bracket away from the quick-release assembly is provided with a receiving groove, the rotating shaft is provided in the receiving groove, and the torsion spring is sleeved on the rotating shaft, and a first end of the torsion spring abutting or connected to the mounting bracket and a second end of the torsion spring abutting or connected to the locking member.

10. An electronic device kit, comprising:
an expansion frame provided with an expansion interface;
the installation structure according to claim 1, wherein the trigger is configured to trigger the first clamping member and the second clamping member to mount or dismount from the expansion interface.
